(19) United States
(12) Patent Application Publication
(10) Pub. No.: US 2018/0303146 A1
(43) Pub. Date: Oct. 25, 2018

(54) NUTRITIONAL COMPOSITION RICH IN WHEAT PROTEINS

(71) Applicant: TEREOS STARCH & SWEETENERS BELGIUM, Aalst (BE)

(72) Inventor: Jeremy MARICHEZ, Marckolsheim (FR)

(73) Assignee: Tereos Starch & Sweeteners Belgium, Aalst (BE)

(21) Appl. No.: 15/769,455

(22) PCT Filed: Oct. 21, 2016
(86) PCT No.: PCT/IB2016/056335

§ 371 Date: Apr. 19, 2018

(30) Foreign Application Priority Data
Oct. 22, 2015 (FR) 15/02238

(51) Int. Cl. A23L 33/185; A23L 33/19; A23K 20/147

(52) U.S. Cl. CPC A23L 33/185; A23L 33/19; A23K 20/147; A23V 2250/5424; A23V 2200/306; A23V 2200/316; A23V 2250/5486; A23V 2002/00

(57) ABSTRACT

Disclosed is a protein mixture and also to a food composition including such a mixture for feeding adult individuals, sportsmen and sportswomen, elderly individuals, or individuals requiring an improvement in their physical condition, such as individuals who are ill, bedridden, in a weak state, undernourished or suffering from sarcopenia. The protein mixture includes a mixture of plant proteins and of milk proteins in a hydrolyzed wheat protein/milk protein weight ratio A of between 55/45 and 20/80, wherein the milk proteins are a mixture of casein and serum proteins in a casein/serum protein weight ratio B of between 70/30 and 20/80.

### FIELD OF THE INVENTION

The present invention relates to a protein mixture as well as a food composition comprising such a mixture for feeding adults, athletes, the elderly or persons requiring an improvement of their physical condition, such as sick persons, bedridden, in a state of weakness, undernutrition or suffering from sarcopenia. According to the invention, the protein mixture comprises a mixture of plant proteins and milk proteins in a ratio A by weight of wheat protein/milk protein comprised between 55/45 and 20/80, the milk proteins being a mixture of casein and serum proteins in a ratio B by weigh of casein/serum proteins comprised between 70/30 to 20/80.

### BACKGROUND OF INVENTION

Numerous studies have shown that animal proteins represent in Europe up to 70% of the average daily protein intake. However, such consumption of animal protein would be responsible for the increase of cardiovascular diseases or cancer in humans. In addition, plant proteins production is much more environmentally friendly considering water consumption, air and soil pollution as well as energy balance.

Plant proteins seem in fact all indicated in the replacement of animal proteins in the alimentation more particularly in view of the replacement of milk proteins. However, in view of the differences in taste, nutritional value and solubility, the proposal of a product with good palatability, good stability, balanced nutritional intake and in which a large portion of the milk proteins are replaced by plant proteins represents a real technological and nutritional challenge.

### DETAILED DESCRIPTION

The invention relates to a protein mixture comprising a mixture of plant proteins and milk proteins in a ratio A by weight of wheat protein/milk protein comprised between 55/45 and 20/80, typically between 50/50 and 25/75, preferably 48/52 and 27/73 and more preferably between 40/60 and 20/80, the milk proteins being a mixture of casein and serum proteins in a ratio B by weight casein/serum proteins comprised between 70/60 to 20/80, preferentially between 60/40 and 30/70.

“Wheat protein” or “gluten” means a water insoluble protein fraction, extracted from wheat flour wet and then dried, also called wheat gluten.

Advantageously, the wheat protein is hydrolyzed. The plant proteins hydrolysates, and in particular wheat protein hydrolysates, are defined as preparations obtained by enzymatic, chemical hydrolysis, or both simultaneously or successively, of plant proteins, and in particular of wheat. Protein hydrolysates comprise a higher proportion of peptides of different sizes and free amino acids than the original composition. This hydrolysis can have an impact on the solubility of proteins. The enzymatic and/or chemical hydrolysis is described, for example, in U.S. Pat. No. 5,280,597 A or J. of Agricultural and Food Chemistry (1965) p. 407-410. Typically, the hydrolysis can be thermal, acidic or enzymatic. Enzymatic hydrolysis is preferred.

The processes for preparing protein hydrolysates are well known to those skilled in the art and may comprise, for example, the following steps: dispersing the proteins in water to obtain a suspension, hydrolysis of this suspension by the chosen treatment. Most often, it will be an enzymatic treatment combining a mixture of different proteases, optionally followed by a heat treatment for inactivating the still active enzymes. The solution obtained can then be filtered on one or more membranes to separate the insoluble compounds, eventually the residual enzyme and the high molecular weight peptides (greater than 10,000 daltons).

Preferably, the hydrolysis of proteins is not complete, that is to say does not result in a composition comprising solely or essentially amino acids and small peptides (from 2 to 4 amino acids). The preferred hydrolysates comprise more than 50%, more preferably more than 60%, even more preferably more than 70%, even more preferably more than 80%, and more particularly more than 90% of proteins and polypeptides of more than 500 Da.

Typically, wheat proteins having an average molecular weight of between 7 and 1000 kDa are obtained by hydrolysis according to methods well known to those skilled in the art [Anfinsen, C. B. Jr. (1965) Advances in Protein Chemistry: v. 20. New York and London: Academy Press]. Typically, the hydrolyzed wheat protein according to the invention has a weight average molecular weight of between 7 and 800 kDa, 5 and 500 kDa or 8 and 100 kDa, preferably between 9 and 80 kDa, more preferably between 10 and 70 kDa, even more preferentially between 12 and 50kDa, even more preferably between 13 and 40kDa. Such peptides are particularly advantageous in that they have an improved solubility (which is reduced during a greater hydrolysis) and unlike a more highly hydrolyzed protein, they have no or very little aftertaste including do not have a bitter taste.

Typically, the wheat protein has a degree of hydrolysis of between 1 and 4, typically between 1.5 to 2.5. The degree of hydrolysis (DH) was determined by the Sorenson titration method.

A wheat gluten particularly suitable for the present invention is MERIPRO® 50O or SOLPRO® 508 marketed by TEREOS SYRAL.

Advantageously, the hydrolyzed wheat protein has a solubility of at least 55% at pH 7 NSI. Typically, the solubility NSI is carried out according to the method described under the reference AACC 46-23.

In the present invention, the term “dairy protein” refers to all proteins derived from milk and milk products. Proteins can be native or hydrolyzed. Dairy protein hydrolysates are defined as preparations obtained by enzymatic hydrolysis, chemically, or both simultaneously or successively, of milk proteins.

From a chemical point of view, milk proteins are distinguished into two groups: caseins and serum proteins. Caseins make up 80% of the total protein in milk. Serum proteins, which represent the remaining 20%, are soluble at pH 4.6.

The “caseins” within the meaning of the invention can be native caseins, acid caseins, rennet caseins, sodium caseinates, potassium caseinates and calcium caseinates. Typically, caseins can be obtained from skimmed milk and precipitated either by acidification with acid or harmless bacterial cultures suitable for human nutrition (acid caseins), or by addition of rennet or other coagulating enzymes. milk (rennet caseins). Caseinates are the products obtained by drying acidic caseins treated with neutralizing agents. Depending on the neutralizing agents used, we obtain caseinates of sodium, potassium, calcium and mixed (=co-neutralization). Native caseins can be obtained from skimmed milk by tangential microfiltration and water diafiltration.

As used herein, the term “serum proteins” refers to whey proteins, preferably lactoglobulins, lactoferrins and immunoglobulins. Typically, whey proteins are mainly composed of β-lactoglobulin (50%), α-lactalbumin (20%), immunoglobulins (10%), bovine serum albumin (10%) and lactoferrin (2.8%).

The respective total protein weights are measured by the method by performing the determination of the soluble nitrogen fraction contained in the sample according to the Kjeldahl method. Then, the total protein level is obtained by multiplying the nitrogen content expressed as a percentage of the weight of dry product by the factor 6.25. This method is well known to those skilled in the art.

The total protein level can also be measured by the determination of the soluble nitrogen fraction contained in the sample according to the method of Dumas A. (Dumas A., 1831, Annals of Chemistry, 33, 342, Buckee, 1994, Journal of the Institute of Brewing, 100, pp 57-64). The total protein level is obtained by multiplying the nitrogen content expressed as a percentage of the weight of dry product by the factor 6.25. This method, also known as method of nitrogen determination by combustion, consists of a total combustion of the organic matrix under oxygen. The gases produced are reduced by copper and then dried and the carbon dioxide is trapped. The nitrogen is then quantified using a universal detector. This method is well known to those skilled in the art.

The invention further relates to a food composition comprising a protein mixture according to the invention.

By “food composition” is meant a composition suitable for use in feeding a mammal.

Advantageously, the food composition is an aqueous composition (liquid or gel) or a solid composition. Advantageously, the food composition is in liquid form, such as a beverage; solid, such as a tablet, a biscuit or a powdery composition; or in the form of a gel, a syrup or a cream. Advantageously, the solid composition is particularly suitable for being dissolved or suspended in an aqueous composition.

Typically, the mixture having a ratio A of between 50/50 and 30/70 because of its neutral taste is particularly advantageous in a food composition having a slight aroma such as a fruit aroma. A ratio A of between 40/60 and 30/70 is particularly advantageous when the food composition must be relatively stable over time before consumption, whereas in the context of rapid solubilization of a powdery food composition, for example, a ratio A between 55/45 and 40/60 is particularly advantageous.

The food composition may for example be a dairy product.

By “dairy product” is meant within the meaning of the present invention any product obtained as a result of any treatment of milk, which may contain food additives and other ingredients functionally necessary for the treatment (CODEX Alimentarius). For the purposes of the present invention, milk is the product of milking a dairy female. Typically, milk and milk products can originate from any animal species such as for example, goat milk, sheep, donkey, or buffalo milk.

Advantageously, the food composition according to the invention also comprises from 8 to 80%, preferably 50 to 70%, of proteins, 0 to 30%, preferably 1 to 15, typically 2 to 5% of lipids; 0 to 50%. typically, 10 to 40% of carbohydrates or complex carbohydrates, the percentages being given per 100 g of dry product.

Typically, the food composition is a dietary supplement or a nutritional composition. Advantageously, it may be a composition intended for feeding young mammals and typically comprises man, pig, horse, ox, dog, cat or sheep.

The composition preferably comprises 5 to 20% by weight of lipid relative to the total weight of the composition. This fat may be of plant and/or animal origin. Preferably, the food composition further comprises a lipid fraction comprising at least one source of omega 3 polyunsaturated fatty acids such as linolenic acid, eicosapentaenoic acid or docosahexaenoic acid, preferably docosahexaenoic acid, or mixtures thereof, in an amount between 20 and 2000 mg when said composition is intended for daily administration, and/or a source of omega 6 polyunsaturated fatty acids such as sesame oil, safflower oil, grape seed oil or any other oil of marine or vegetable origin rich in omega 6; wherein the omega 6 to omega 3 ratio being preferably between 1 and 5.

Typically, said source of omega 3 fatty acids is chosen from ruminant milk fat, fish oil, algae, rapeseeds, coconut palm linseed oil or any other oil of the invention. marine or plant origin rich in omega 3 and said source of omega 6 is selected from sesame oil, safflower oil, grape seed oil or any other oil of marine origin or plant rich in omega 6.

The composition generally also contains a number of additives such as carbohydrates, synthetic essential amino acids, minerals and vitamins.

The amount of carbohydrate or complex carbohydrate is 5 to 30% by weight. Suitable carbohydrates are starch, lactose, sucrose, fructose, dextrose or a mixture thereof.

The amount of synthetic essential amino acids represents 0 to 3% by weight of the composition. These added amino acids confer on the composition the necessary balance in amino acids. Typical amino acids that can be added are: lysine, threonine, methionine, histidine and tryptophan.

The food composition further comprises 2 to 5% by weight of vitamins and minerals. Typically, these vitamins and minerals can be in the form of a premix. Such premixes are known to specialists and usually contain calcium, chalk, trace elements as well as vitamins.

Advantageously, the composition comprises, vitamins such as vitamin A, B1, B2, B5, B6, B8, B9, B12, C, D, E, K, PP, in an amount preferably between 0 g and 120 mg when it is intended for daily administration.

Typically, the food composition further comprises trace elements and/or minerals, such as selenium, zinc, copper, the amount of which can be up to 800 mg when said composition is intended for daily administration.

Advantageously, the food composition further comprises one or more ingredients selected from prebiotics, probiotics, coenzyme Q10, antioxidants, texturizing agents, colorants, thickeners, flavors, or a mixture.

Preferably, the food composition further comprises a carbohydrate fraction in an amount of between 10 and 80 g when said composition is intended for daily administration.

Typically, the food composition according to the invention is in liquid form and comprises between 2 and 30 g of said protein mixture per 100 ml, preferably between 12 and 22 g per 100 ml.

When the food composition is a composition for the replacement of milk, for example veal milk, it is given in the form of an emulsion in water. The emulsion preferably contains 12.5 to 17.5 g of composition per 100 ml of emulsion.

The invention further relates to the use of the composition according to the invention in the replacement of a mammalian milk, preferably calf, preferably, said composition has a ratio A of between 40/60 and 20/80.

The invention relates to the use of the composition according to the invention as a dietary supplement or in nutrition programs of refeeding or nutritional supplementation or to meet the nutritional deficiencies of adults, athletes, the elderly, or people who need to improve their physical condition, such as people who are sick, bedridden, weak, undernourished or suffering from sarcopenia.

Typically, according to the invention, the dietary supplement or the nutritional composition is advantageous in that it is rich in protein. Typically, according to the invention, the maintenance or the improvement of the physical condition comprises the improvement of the muscular performances, the maintenance of the muscular mass, the improvement of the muscular synthesis, the improvement of the physical performances and the resistance to fatigue, improvement of physical mobility, improvement of the response to refeeding, preservation of bone density.

Although having distinct meanings, the terms “comprising”, “containing”, “comprising” and “consisting of” have been used interchangeably in the description of the invention and may be replaced by the other.

The invention will be better understood on reading the following figures and examples given solely by way of example.

### EXAMPLES The present invention is further illustrated by the following examples.

### Example 1

### Organoleptic Quality of Different Sources of Plant Proteins

In order to develop a protein-rich beverage for athletes with plant proteins, the taste quality of different plant sources has been evaluated. Their ability to combine optimally with the most common flavoring used in this type of application such as fruity, vanilla or chocolate flavorings were first evaluated.

In order to define which of the vegetal origins of plant proteins is best able to combine optimally with the common flavors used in protein-rich beverages for athletes, various sensory tests have been carried out.

In a first session, the different plant sources of plant proteins were evaluated according to a method described by William A A and Langron S P (William A A and Langron S P, 1984. The use of free-choice profiling for the evaluation of commercial ports. to generate descriptors to discriminate in the most complete manner the different proteins tested. For this, solutions of each of the proteins at a concentration of about 15% were prepared and presented in random order and anonymously to a group of 20 tasters. The proteins tested are as follows:
Hydrolyzed wheat proteins MERIPRO® 500 from TEREOS and GBSP51® from CHAMTOR
ADM CLARISOY® 150 Soy Protein Isolate (SPI)
Pisane® F9 Pea Protein Isolate (PPI) from COSUCRA

The descriptors generated during this session were then collected and discussed with the entire panel of tasters in order to reach a consensus on the most discriminating between the different botanical origins of proteins tested.

TABLE 1
Main descriptors generated during the free choice profile session of the
descriptors

| | Hydrolyzed | | Soy Protein | |
|---|---|---|---|---|
| | Wheat Protein | Hydrolyzed | Isolate | Pea Protein |
| | MERIPRO ® | Wheat Protein | CLARISOY ® | Isolate |
| | 500 | GBSP51 ® | 150 | Pisane ® F9 |
| Descriptors | Cereal slightly | Raw cereal, | Green | Green |
| | toasted, bread | lactic | vegetable, light | vegetable, |
| | fermenting, | fermentation, | note of raw | broth, |
| | slightly | slight acidity | cereal broth, | bitterness |
| | sweetened | | bitterness | |

From this first series of sensory tests, it appeared that compared to pea or soy protein, hydrolyzed wheat proteins combine more optimally with vanilla and chocolate flavorings. In fact, the notes perceived in the case of hydrolyzed wheat proteins correspond to the same aromatic families characterizing the vanilla and chocolate flavorings, whereas the notes perceived in the case of tested proteins of soybeans or peas are too far apart.

In a second step, in order to verify the adequacy between the aromatic profiles of the different botanical origins of plant proteins and the more sensitive flavoring of fruity type, a second session of profile test was carried out according to a standardized method (Norm NF ISO 13299: 2003 “sensory analysis—methodology—general guidelines for the establishment of a sensory profile”) on the basis of the following descriptors: fruity aromatization, bitterness, acidity and global appreciation. For this, 5% of each of the following proteins were added to a multifruit fruit juice base: MERIRO® 500 hydrolyzed wheat protein from TEREOS and ADM CLARISOY® 150 soy protein isolate (SPI). In summary, this second test has made it possible to demonstrate that the bitterness of the soy isolate and its particular aromatic notes generate a general appreciation significantly lower.

Therefore, in view of the results of these different sensory evaluations, hydrolyzed wheat proteins appear to be better candidates for the formulation of powder mixtures for the preparation of protein-rich beverages for athletes.

### Example 2

### Dispersibility and Foaming Properties of Hydrolyzed Wheat Proteins Compared to Milk Proteins

An additional advantage of using plant proteins in these protein-rich beverage applications is their significantly lower price compared to concentrated animal proteins such as for example milk proteins, which are used very frequently in these applications because of their composition. in amino acids. As a result, the use of plant proteins to replace a fraction of concentrated animal proteins advantageously makes it possible to reduce the final cost of such formulations without reducing their nutritional value. In this respect, the hydrolyzed wheat proteins have been compared to different milk proteins alone or in combination on a set of criteria determining the quality of protein-rich beverages for athletes.

The tested proteins are:
Hydrolyzed wheat proteins MERIPRO® 500 from TEREOS and GBSP51® from CHAMTOR
INGREDIA NUTRITIONAL PRODIET® 85 Rich Casein Protein (90%) Protein Isolate
INGREDIA NUTRITIONAL PRODIET® 90 Whey Protein Isolate

Dispersibility and foaming properties are important in the case of powder compositions for use in the preparation of ready-to-drink high protein beverages. Indeed, these drinks are most often prepared at the place of consumption and brought to be swallowed quickly. In this case, it is necessary for these powder compositions to disperse completely and rapidly in order to ensure optimum quality of the beverage prepared in this way, avoiding to the consumer any unpleasant experience such as for example the presence of lumps consisting of particles of undispersed and unhydrated powder that could cause coughing during exercise. On this last point, an important foaming can also be problematic for the consumption of these drinks in good conditions.

In order to evaluate the dispersibility and foaming properties of different combinations of hydrolyzed wheat protein, casein-rich milk protein isolate and whey isolate, 30 g of each powder mixture was mixed with 200 mL of mineral water (Vittel®) using a special shaker for the preparation of high-protein sports drinks (Blender Bottle®).

The dispersibility and foaming properties were evaluated by shaking the shaker five times for the preparation of the beverage and then passing the entire mixture through a stainless steel screen opening of 400 μm.

Foaming properties are defined by the absence or presence of foam, by the evaluation of the thickness and the diameter of the layer of foam present on the sieve and its duration from the moment the mixture was passed through the sieve. This property is evaluated as:
++ when no foam is present on the sieve
−− when the foam is thick and remains on the sieve for a longer or shorter duration

Dispersibility properties are defined by the absence or presence of lumps on the sieve, their size and their life from the moment the mixture was passed through the sieve. This property is noted:
++ when no lumps are present on the sieve
−− when many large lumps remain on the sieve for a longer or shorter duration

TABLE 2
dispersibility and foaming properties of the different protein sources
tested in isolation

| | Hydrolyzed | | Casein-rich | Whey |
|---|---|---|---|---|
| | Wheat | Hydrolyzed | milk protein | protein |
| | Protein | Wheat | isolate | isolate |
| | MERIPRO ® | Protein | PRODIET ® | PRODIET ® |
| | 500 | GBSP51 ® | 85 | 90 |
| Foaming | − − | − − | + + | − |
| Dis- | − − | − | + + | + + |
| persibility | | | | |

The first observation that has been made during these tests is that even considering that the hydrolyzed wheat proteins appear as better candidates for this application from the point of view of their organoleptic quality, their lower dispersibility as well as their tendency to foaming can represent a limit for the preparation of protein-rich beverages for athletes. Based on these tests, hydrolyzed wheat proteins have been shown to have relatively low dispersibility and foaming in comparison to milk proteins. Among the milk proteins tested, the casein-rich milk protein isolate has the best balance of dispersibility and foaming compared to the whey protein isolate. In fact, at first glance, the whey protein isolate does not seem to be recommended because of its tendency to foaming.

In order to compensate for the limitations related to the dispersibility and foaming properties, a combination of wheat proteins hydrolyzed with milk proteins has been envisaged. In addition to potentially improving the technological properties of the mixture, the combination of milk proteins with hydrolyzed wheat proteins could enrich the amino acid composition of the mixture.

### Example 3

### Comparison of the Quality of Protein Combinations on the Basis of the PDCAAS Score

In order to propose a mixture that would have the best nutritional and functional qualities, different combinations have been envisaged.

The quality assessment of these protein combinations was carried out in accordance with the latest report published in 2001 on athlete nutrition issued by the European Scientific Committee on Food. According to this report, a minimum protein quality level of 70% based on NPP (Net Protein Use) score is recommended for enriched and protein-rich products for athletes. According to FAO/WHO publications, it is generally accepted that PDCAAS is a relevant criterion for measuring the quality of a protein for human nutrition (Schaafsma, 2010). Journal of Nutrition Vol 130 No. 7). This method compares the concentration of the first limiting essential amino acid of the tested protein or protein mixture with the concentration of the same amino acid in the composition of a reference protein. The amino acid composition of this reference protein is defined according to the category of consumer considered and its specific requirements for essential amino acids. When the PDCAAS score exceeds the value of 100%, it is truncated by default to 100%.

TABLE 3
PDCAAS Score for different combinations of hydrolyzed wheat
proteins MERIPRO ® 500/PRODIET ® 85 casein milk protein
isolate/PRODIET ® Whey isolate 90

| | 70/15/15 | 60/20/20 | 50/25/25 | 40/30/30 | 30/35/35 |
|---|---|---|---|---|---|
| PDCAAS score | 70% | 89.9 | 100 | 100 | 100 |

Based on this simulation, we can conclude that a combination of 70% hydrolyzed wheat protein/15% casein/15% whey protein achieves the minimum quality value of the protein fraction of 70%. The optimum quality value of the 100% protein fraction is achieved by combining a maximum of 50% hydrolyzed wheat protein with 25% casein and 15% whey protein isolate.

### Example 4

### Dispersibility and Foaming Properties of Different Combinations of Hydrolyzed Wheat Proteins and Milk Proteins

The dispersibility and foaming properties of different protein combinations were evaluated in powder recipes allowing the preparation of a high-protein drink according to the method described in Example 2. Apart from the protein fraction, the recipe also includes sodium chloride and an aroma (vanilla, banana . . . ). The recipes tested are detailed in Table 3 below.

TABLE 4
Composition of tested recipes containing different combinations of
hydrolyzed wheat protein MERIPRO ® 500/Casein Milk Protein Isolate
PRODIET ® 85/Whey Isolate PRODIET ® 90. The recipes are expressed
in % of the total weight of the mixture

| | Mixture A | Mixture B | Mixture C | Mixture D |
|---|---|---|---|---|
| Hydrolyzed | 57.6 | 48 | 38.4 | 28.8 |
| wheat protein | | | | |
| MERIPRO ® | | | | |
| 500 | | | | |
| Casein Milk | 19.2 | 24 | 28.8 | 33.6 |
| Protein Isolate | | | | |
| PRODIET ® | | | | |
| 85 | | | | |
| Whey Isolate | 19.2 | 24 | 28.8 | 33.6 |
| PRODIET ® | | | | |
| 90 | | | | |
| Sodium | 1 | 1 | 1 | 1 |
| chloride | | | | |
| Aroma | 3 | 3 | 3 | 3 |

The recommended dosage tested for the preparation of a protein-enriched beverage is: ˜15 g in 100 mL of water. This recommended dosage allows the preparation of a high-protein drink that provides ˜10 g of protein per 100 mL serving.

The results obtained are shown in Table 5.

TABLE 5
Dispersibility and Foaming Properties of Different Combinations of
Hydrolyzed Wheat Proteins MERIPRO ® 500/PRODIET ® 85 Casein
Milk Protein Isolate/PRODIET ® Whey Isolate 90

| | Mixture A | Mixture B | Mixture C | Mixture D |
|---|---|---|---|---|
| Foaming | − − | − − | + | + + |
| Dispersibility | − − | + | + + | + + + |

Based on these tests and considering the results obtained on the isolated protein sources (Table 2, Example 2), it is found that increasing the proportion of milk proteins in the mixture improves dispersibility and reduces foaming. On this point, it can be concluded that a good balance between foaming and dispersibility starts is observed for a mixture having less than 50% hydrolyzed wheat protein. Moreover, it is also found that, contrary to what was observed during the test on isolated whey protein (Table 2, Example 2), the negative effect of whey proteins on foaming is no longer observed when these proteins are in combination with caseins and wheat proteins. Indeed, a marked reduction of this foaming property begins to be observed for the mixtures containing 25% of casein-rich milk protein isolate and 25% of whey protein isolate, the mixture containing 35% of each of these proteins. dairy proteins giving the best results.

### Example 5

### Stability of Protein-Rich Beverages after Shaker Preparation

The stability of a protein-rich beverage prepared from a powder mixture is a critical parameter since it impacts its homogeneity and can therefore impact its ability to meet the nutritional needs of the sports consumer optimally. The stability of the different protein sources as well as their combinations was evaluated 10 and 30 minutes after shaker preparation. It was measured according to the presence and thickness of a precipitation layer.

It is noted:
+++ in the case where no sedimentation layer is observed over time in the case where a significant layer of sedimentation is observed and quickly after the preparation of the drink
−−− in the case where a significant layer of sedimentation is observed and quickly after the preparation of the drink

TABLE 6
Stability of different protein sources tested in isolation

| | Hydrolyzed | | Casein-rich | Whey |
|---|---|---|---|---|
| | Wheat | Hydrolyzed | milk protein | protein |
| | Protein | Wheat | isolate | isolate |
| | MERIPRO ® | Protein | PRODIET ® | PRODIET ® |
| | 500 | GBSP51 ® | 85 | 90 |
| Stability | − | − | + | + + + |
| after | | | | |
| 10 minutes | | | | |
| Stability | − − − | − − − | − | + + + |
| after | | | | |
| 30 minutes | | | | |

Based on these tests, it has been observed that the hydrolyzed wheat proteins have a rather low stability compared to the dairy proteins. Of the milk proteins, whey proteins are optimally stable compared to casein-rich milk proteins with a very early sedimentation layer.

TABLE 7
Stability of various tested combinations of hydrolyzed wheat protein
MERIPRO ® 500/PRODIET ® 85 Casein Milk Protein Isolate/
PRODIET ® Whey Isolate 90

| | Mixture A | Mixture B | Mixture C | Mixture D |
|---|---|---|---|---|
| Stability after | + + + | + + | + | + |
| 10 minutes | | | | |
| Stability after | − − − | − − | − | − |
| 30 minutes | | | | |

On the basis of these tests and considering the results obtained with the protein sources tested in isolation (Table 6), it has surprisingly been observed that an increase in the proportion of milk proteins in the mixture improves the stability in the mixture. duration but does not improve stability in the short term. In this context, since in the case of preparation and consumption by athletes it is performed quickly within a few minutes after preparation, it appears that an ideal compromise is found with the mixture 50% hydrolyzed wheat protein/25% casein/25% whey protein. Mixes containing 60% to 70% milk protein for 30 to 40% hydrolyzed wheat protein seem particularly suitable for a delayed consumption such as the replacement of milk intended for calves.

### Example 6

### Organoleptic Quality of the Tested Combinations of Hydrolyzed Wheat Proteins and Dairy Proteins

Finally, in order to conclude on the general quality of each recipe tested, the organoleptic quality of the various combinations was evaluated as described in Example 1. The different recipes were tested at a dosage of 15 g of powder mixed with 100 mL of water but in the absence of aroma in order to discriminate them at best.

TABLE 8
organoleptic quality of the different combinations tested

| | Mixture A | Mixture B | Mixture C | Mixture D |
|---|---|---|---|---|
| Taste | Slightly | Toasted | No real | Milk, cream |
| | toasted cereal, | cereal | dominant note | and light |
| | butter biscuit, | | | bitterness |
| | slightly sweet | | | |
| Global | Typed but | Aromatic | Aromatic | Typed but |
| Appreciation | nice | neutrality | neutrality | still nice |

It is noted that the organoleptic qualities of mixtures A and D allow consumption such as that without adding flavor, while mixtures B and C have a sufficiently neutral taste for use with a large group of aromata such as flavors of fruits.

Taking into account the different criteria that have been evaluated on the different combinations, it has been observed that a better compromise between foaming/dispersibility properties, stability of the protein-rich beverage, quality score of the protein mixture and taste appears to be the blend of 40% hydrolyzed wheat protein/30% Casein/30% whey protein.

1-10. (canceled)

11. A protein mixture comprising a mixture of plant proteins and milk proteins in a ratio A by weight of hydrolyzed wheat protein/milk protein comprised between 55/45 and 20/80, the milk proteins being a mixture of casein and serum proteins in a ratio B by weight of casein/serum proteins comprised between 70/30 to 20/80.

12. The protein mixture according to claim 11, wherein the ratio B is comprised between 60/40 and 30/70.

13. The protein mixture according to claim 11, wherein the ratio A is comprised between 50/50 and 25/75.

14. The protein mixture according to claim 11, wherein the ratio A is comprised between 40/60 and 30/70.

15. The protein mixture according to claim 11, wherein the ratio A is comprised between 40/60 and 20/80.

16. The protein mixture according to claim 11, wherein the ratio A is comprised between 50/50 and 25/75 and the ratio B is comprised between 60/40 and 30/70.

17. The protein mixture according to claim 11, wherein the ratio A is comprised between 40/60 and 30/70 and the ratio B is comprised between 60/40 and 30/70.

18. The protein mixture according to claim 11, wherein said wheat proteins have an average molecular mass comprised between 7 and 1000 kDa.

19. A food composition comprising a protein mixture according to claim 11.

20. The food composition according to claim 19, further comprising from 8 to 80% of proteins, 0 to 30% of lipids, 0 to 50% of carbohydrates or complex carbohydrates, the percentages being indicated per 100 g of dry product.

21. The food composition according to claim 19, wherein the food composition is an aqueous composition.

22. The food composition according to claim 19, wherein the food composition is an aqueous composition in a liquid form selected from a group consisting of beverages, gels, syrups and creams.

23. The food composition according to claim 19, wherein the food composition is a solid composition.

24. The food composition according to claim 19, wherein the food composition is a solid composition selected from a group consisting of tablets, a biscuits and powdery compositions.

25. The food composition according to claim 19, wherein the food composition is in liquid form and comprises between 2 and 30 g of said protein mixture per 100 ml.

26. A nutritional method comprising the feeding of the food composition according to claim 19 to a subject in need thereof.

27. The nutritional method according to claim 24, wherein the subject is a mammal selected from a group consisting of humans, pigs, horses, oxen, dogs, cats and sheep.

28. The nutritional method according to claim 24, wherein the method is a dietary supplementation method, a nutritional program of refeeding, a nutritional supplementation method or a method to overcome the deficiencies of adults, athletes, the elderly, or persons in need of improvement their physical condition; wherein the persons in need of improvement their physical condition are selected from a group consisting of sick, bedridden, weak, malnourished or suffering from sarcopenia.

29. The nutritional method according to claim 24, wherein the nutritional method is for maintaining or improving the physical condition of a subject in need thereof.

30. The nutritional method according to claim 24, wherein the method is for maintaining or improving the physical condition selected from: improving muscle performance, maintaining muscle mass, improving muscle synthesis, improving physical performance and improving resistance to fatigue, improvement of physical mobility, improvement of the response to refeeding and preservation of bone density.
